(19) United States
(12) Patent Application Publication
(10) Pub. No.: US 2011/0138629 A1
(43) Pub. Date: Jun. 16, 2011

(54) Wire and cable stripper

(76) Inventor: Jen Kai Liu, Taipei (TW)

(21) Appl. No.: 12/896,922

(22) Filed: Oct. 4, 2010

(30) Foreign Application Priority Data
Dec. 16, 2009 (TW) 098223613

(51) Int. Cl. H02G 1/12

(52) U.S. Cl. 30/90.1

(57) ABSTRACT

Embodiments of the invention relate to a wire and cable stripper for cutting the insulation layer off from a wire or a cable. The benefits of the wire and cable stripper include offering a wire or cable cutter that has simple construction, allowing convenience in transportation, and reducing the component number for easy mass production.

### BACKGROUND OF THE INVENTION

1. Field of Invention

The invention relates to wire and cable stripper and more particularly to a wire and cable stripper that cuts the insulation layer off from a wire or a cable.

2. Description of Related Art

Wire and cable stripper is a common tool that cuts off an insulation layer of a wire or cable. Moreover, a common way to make a direct cut to the insulation layer is by using a knife or a pair of needle nose pliers in addition to a pair of sharp-nose pliers.

However, the methods are both challenging techniques to a user and can cause breakage or over-bending to a wire if the technique is not used correctly.

Therefore, there is a need in the market for improving the functionality deficiency and causes the development of many different types of wire and cable stripper.

However, the methods of achieving the cut is typically by clamping the cable or wire tightly onto the wire and cable stripper, then by either rotating the wire and cable stripper, the cable, or wire itself, and then making the cut on the insulation layer of the wire or cable by utilizing a cutting piece mounted on the wire and cable stripper.

There have been a number of prior wire and cable stripper patents, for example, Taiwan Patent Numbers M354267, M452271, and M582656, and U.S. Pat. Nos. 4,955,137 and 4,945,788. Despite prior patents reveal the functionality of cutting the insulation layer of a wire or cable, there are still many shortcomings. For example, the size of the wire and cable stripper is large and complicated assembly process that involves numerous components and parts.

Therefore, not only the prior wire and cable stripper is inconvenient to carry, but also is very complicated to manufacture and not suitable for mass production.

The inventor of the invention, having many years of extensive development and manufacturing expertise in the related field, takes these shortcomings into consideration and thinks through the details, and has finally developed a simple structure for a novel wire and cable stripper.

### SUMMARY OF THE INVENTION

The objective of the invention is to offer a wire and cable stripper which cuts the insulation layer off from a wire or a cable. Furthermore, the construction of the wire and cable stripper is convenience to carry around.

The invention is accomplished through the following technical programs:

A wire and cable stripper for cutting off an insulation layer of a cable or a wire, the wire and cable stripper comprising: a first clamp handle part having a front of the first clamp handle part and a rear of the first clamp handle part; a slot disposed at the rear of the first clamp handle part; a second clamp handle part having a front of the second clamp handle part and a rear of the second clamp handle part wherein the front of the second clamp handle part has a cavity, the rear of the second clamp handle part has a movable part of the slot of the corresponding rear of the first clamp handle part, the movable part of the rear of the second clamp handle part and the slot of the rear of the first clamp handle part push against each other, and the first clamp handle part and the second clamp handle part are connected together through a deformable connecting piece; the first clamp handle part and the second clamp handle part are connected through only one deformable connecting piece; the first clamp handle part and the second clamp handle part are connected by the deformable connecting piece to form integrally as a single body; and a cutting piece disposed inside the cavity wherein a portion of the cutting piece protrudes out of a surface of the cavity of the front of the second clamp handle part.

When applying external forces to the rear of the first clamp handle part and the rear of the second clamp handle part, the movable part of the rear of the second clamp handle part will start to displace along the slot of the rear of the first clamp handle part, stress the connecting piece and cause it to deform, the front of the first clamp handle part and the front of the second clamp handle part will displace reversely from each other, and a wire or cable will placed in the cavity. The connecting piece tends to restore to its original position automatically when the external forces are removed. Furthermore, the reverse displacement of both the front of the first clamp handle part and the front of the second clamp handle part will also tend to disappear. This movement causes the front of the first clamp handle part and the front of the second clamp handle part to move closer to one and other and secures the previously placed wire or cable.

After the wire or cable is secured, followed by rotating the wire and cable stripper, the cutting piece will make a cut on the insulation layer of the wire or cable; or by fixating the wire and cable stripper, followed by rotating the wire or cable to allow the cutting piece to make a cut on the insulation layer of the wire or cable.

The invention is accomplished through the following technical programs:

A wire and cable stripper for cutting off an insulation layer of a cable or a wire, the wire and cable stripper comprising: a first clamp handle part having a front of the first clamp handle part and a rear of the first clamp handle part; a slot disposed at the rear of the first clamp handle part; a cavity disposed at the front of the first clamp handle part; a second clamp handle part having a front of the second clamp handle part and a rear of the second clamp handle part wherein the rear of the second clamp handle part has a movable part of the slot of the corresponding rear of the first clamp handle part, the movable part of the rear of the second clamp handle part and the slot of the rear of the first clamp handle part push against each other, and the first clamp handle part and the second clamp handle part are connected together through a deformable connecting piece; the first clamp handle part and the second clamp handle part are connected through only one deformable connecting piece; the first clamp handle part and the second clamp handle part are connected by the deformable connecting piece to form integrally as a single body; and a cutting piece disposed inside the cavity wherein a portion of the cutting piece protrudes out of a surface of the cavity of the front of the first clamp handle part.

When applying external forces to the rear of the first clamp handle part and the rear of the second clamp handle part, the movable part of the rear of the second clamp handle part will start to displace along the slot of the rear of the first clamp handle part, stress the connecting piece and cause it to deform, the front of the first clamp handle part and the front of the second clamp handle part will displace reversely from each other, and a wire or cable will placed in the cavity. The connecting piece tends to restore to its original position automatically when the external forces are removed. Furthermore, the reverse displacement of both the front of the first clamp handle part and the front of the second clamp handle part will also tend to disappear. This movement causes the front of the first clamp handle part and the front of the second clamp handle part to move closer to one and other and secures the previously placed wire or cable.

After the wire or cable is secured, followed by rotating the wire and cable stripper, the cutting piece will make a cut on the insulation layer of the wire or cable; or by fixating the wire and cable stripper, followed by rotating the wire or cable to allow the cutting piece to make a cut on the insulation layer of the wire or cable.

The benefits of the invention include offering a wire or cable cutter that has simple construction, allowing convenience in transportation, and reducing the component number for easy mass production.

The above and other objects, features and advantages of the invention will become apparent from the following detailed description taken with the accompanying drawings.

### BRIEF DESCRIPTION OF THE DRAWINGS

FIG. 1 is a front view of a wire and cable stripper according to a first preferred embodiment of the invention;

FIG. 1A is a sectional view taken along line A′-A of FIG. 1;

FIG. 2 is a perspective view of a wire or cable placed in the open wire and cable stripper after external force is applied;

FIG. 3 is a perspective view of an insulating layer of a wire or cable is being cut after the wire and cable stripper closes;

FIG. 4 is a front view of blade base of a wire and cable stripper according to a second preferred embodiment of the invention;

FIG. 4A is an enlarged view of the cutting piece illustrated in FIG. 4;

FIG. 5 is a perspective view of a wire or cable placed in the open wire and cable stripper after external force is applied;

FIG. 6 is a perspective view of an insulating layer of a wire or cable is being cut after the wire and cable stripper closes;

FIG. 7 is a front view of a wire and cable stripper according to a third preferred embodiment of the invention;

FIG. 7A is a sectional view taken along line A′-A of FIG. 7;

FIG. 8 is a perspective view of a wire or cable is placed in the open wire and cable stripper after external force is applied;

FIG. 9 is a perspective view of an insulating layer of a wire or cable is being cut after the wire and cable stripper closes;

FIG. 10 is a front view of a wire and cable stripper having a blade base according to a fourth preferred embodiment of the invention;

FIG. 10A is an enlarged view of the cutting piece illustrated in FIG. 10;

FIG. 11 is a perspective view of a wire or cable is placed in the open wire and cable stripper after external force is applied; and

FIG. 12 is a perspective view of an insulating layer of a wire or cable is being cut after the wire and cable stripper closes;

### DETAILED DESCRIPTION OF THE INVENTION

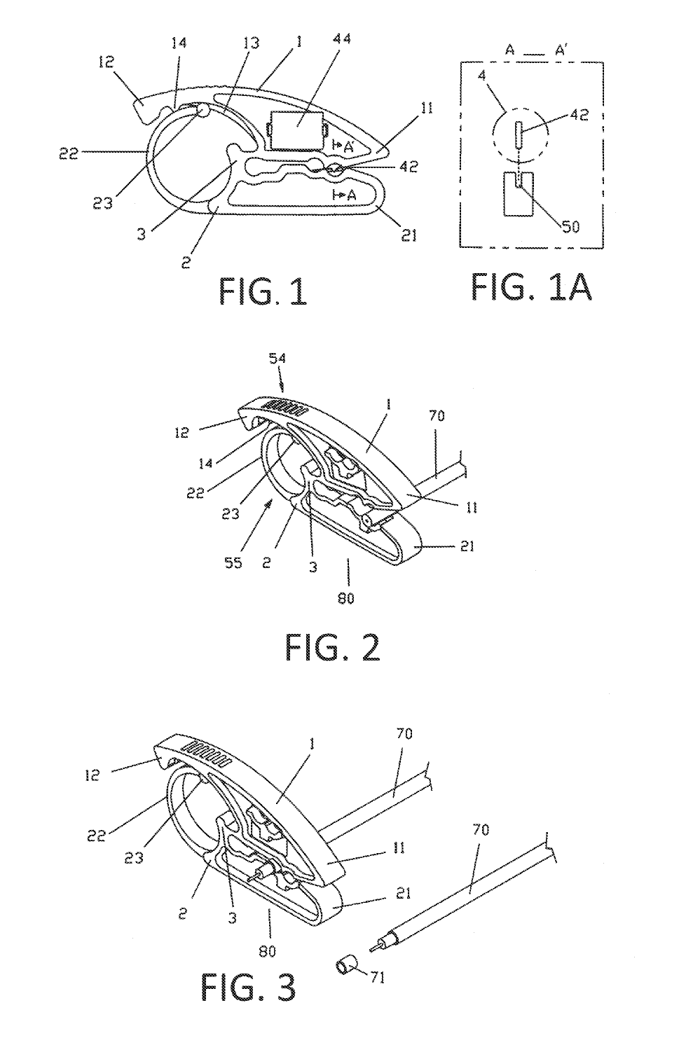

Referring to FIGS. 1 to 3, a wire and cable stripper 80 in accordance with a first preferred embodiment of the invention is shown. The wire and cable stripper 80 is applicable in cutting off an insulation layer 71 of a wire or cable 70. The wire and cable stripper 80 comprises the following components.

A first clamp handle part 1 has a front of the first clamp handle part 11 and a rear of the first clamp handle part 12. Moreover, there is a slot 13 at the rear of the first clamp handle part 12. A second clamp handle part 2 has a front of the second clamp handle part 21 and a rear of the second clamp handle part 22. A cavity 50 is disposed at the front of the second clamp handle part 21. The rear of the second clamp handle part 22 has a movable part 23 of the slot 13 of the corresponding rear of the first clamp handle part 12. The movable part 23 of the rear of the second clamp handle part 22 and the slot 13 of the rear of the first clamp handle part 12 push against each other. A connecting piece 3 connects the second clamp handle part 2 and the first clamp handle part 1. Moreover, the connecting piece 3 is a deformable component when user exerts a clamping force thereon. A cutting piece 4 which is a blade 42 installed in the cavity 50.

When applying external forces 54, 55 to the rear of the first clamp handle part 12 and the rear of the second clamp handle part 22, the movable part 23 of the rear of the second clamp handle part 22 will start to displace along the slot 13 of the rear of the first clamp handle part 12, stress the connecting piece 3 and cause it to deform, the front of the first clamp handle part 11 and the front of the second clamp handle part 21 will displace reversely from each other, and a wire or cable 70 will placed in the cavity 50. The connecting piece 3 tends to restore to its original position automatically when the external forces 54, 55 are removed. Furthermore, the reverse displacement of both the front of the first clamp handle part 11 and the front of the second clamp handle part 21 will also tend to disappear. This movement causes the front of the first clamp handle part 11 and the front of the second clamp handle part 21 to move closer to one and other and secures the previously placed wire or cable 70.

After the wire or cable 70 is secured, followed by rotating the wire and cable stripper 80, the cutting piece 4 will make a cut on the insulation layer of the wire or cable 70; or by fixating the wire and cable stripper 80, followed by rotating the wire or cable 70 to allow the cutting piece to make a cut on the insulation layer 71 of the wire or cable 70.

Also in this embodiment, the first clamp handle part 1 and the second clamp handle part 2 are connected together through only one connecting piece 3.

Also in this embodiment, the first clamp handle part 1, the second clamp handle part 2, and the connecting piece 3 are connected together as one integral body.

Also in this embodiment, a position limiting piece 14 is installed at the rear of the first clamp handle part 12 of the wire or cable stripper 80, the position limiting 14 provides a limiting movable trajectory of the first clamp handle part 1 for the movable part 23 of the rear of the second clamp handle part.

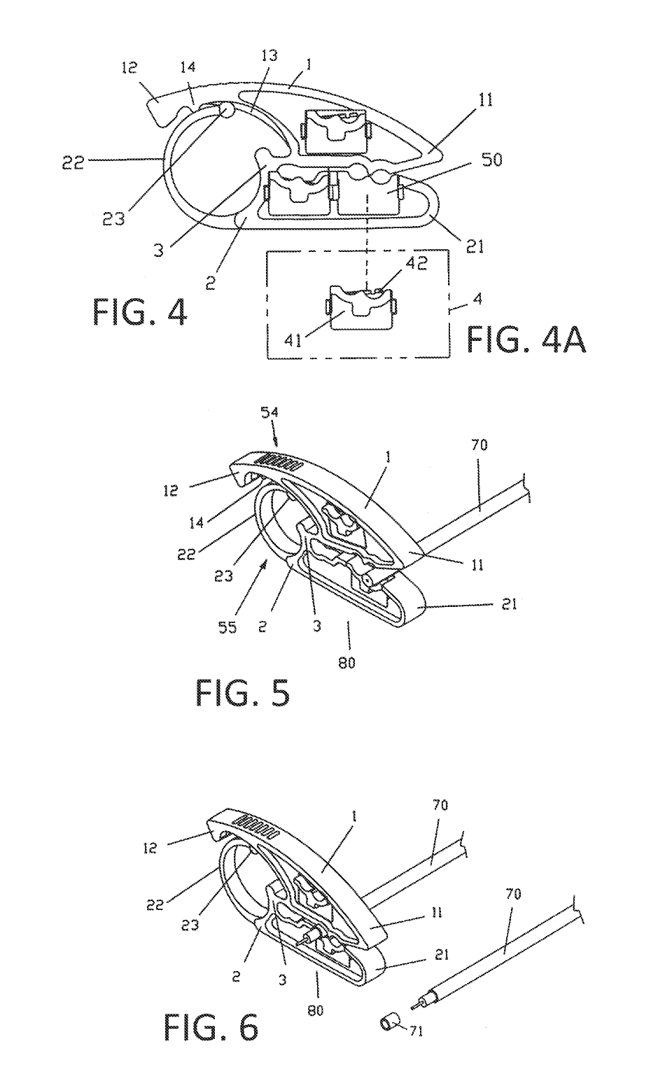

Referring to FIGS. 4 to 6, a wire and cable stripper in accordance with a second preferred embodiment of the invention is shown. The wire and cable stripper 80 is applicable in cutting off an insulation layer 71 of a wire or cable 70. The wire and cable stripper 80 comprises the following components.

A first clamp handle part 1 has a front of the first clamp handle part 11 and a rear of the first clamp handle part 12. Moreover, there is a slot 13 at the rear of the first clamp handle part 12. A second clamp handle part 2 has a front of the second clamp handle part 21 and a rear of the second clamp handle part 22. A cavity 50 is disposed at the front of the second clamp handle part 21. The rear of the second clamp handle part 22 has a movable part 23 of the slot 13 of the corresponding rear of the first clamp handle part 12. The movable part 23 of the rear of the second clamp handle part 22 and the slot 13 of the rear of the first clamp handle part 12 push against each other. A connecting piece 3 connects the second clamp handle part 2 and the first clamp handle part 1.

Moreover, the connecting piece 3 is a deformable component when user exerts a clamping force thereon. A cutting piece 4 includes a blade base 41 and a blade 42. The blade 42 is installed on the blade base 41. The cutting piece 4 is installed in the cavity 50.

When applying external forces 54, 55 to the rear of the first clamp handle part 12 and the rear of the second clamp handle part 22, the movable part 23 of the rear of the second clamp handle part 22 will start to displace along the slot 13 of the rear of the first clamp handle part 12, stress the connecting piece 3 and cause it to deform, the front of the first clamp handle part 11 and the front of the second clamp handle part 21 will displace reversely from each other, and a wire or cable 70 will placed in the cavity 50. The connecting piece 3 tends to restore to its original position automatically when the external forces 54, 55 are removed. Furthermore, the reverse displacement of both the front of the first clamp handle part 11 and the front of the second clamp handle part 21 will also tend to disappear. This movement causes the front of the first clamp handle part 11 and the front of the second clamp handle part 21 to move closer to one and other and secures the previously placed wire or cable 70.

After the wire or cable 70 is secured, followed by rotating the wire and cable stripper 80, the cutting piece 4 will make a cut on the insulation layer of the wire or cable 70; or by fixating the wire and cable stripper 80, followed by rotating the wire or cable 70 to allow the cutting piece to make a cut on the insulation layer 71 of the wire or cable 70.

Also in this embodiment, the first clamp handle part 1 and the second clamp handle part are connected together through only one connecting piece 3.

Also in this embodiment, the first clamp handle part 1, the second clamp handle part 2, and the connecting piece 3 are connected together as one integral body.

Also in this embodiment, a position limiting piece 14 is installed at the rear of the first clamp handle part 12 of the wire or cable stripper 80, the position limiting 14 provides a limiting movable trajectory of the first clamp handle part 1 for the movable part 23 of the rear of the second clamp handle part.

Also in this embodiment, a cutting piece storage space 44 is installed at the front of the first clamp handle part 11 of the wire or cable stripper 80. Furthermore, the cutting piece storage space 44 can carry cutting pieces 4 of various dimensions. Hence, different kinds of wire or cable can be stripped by changing cutting piece 4 of different sizes.

Also in this embodiment, a cutting piece storage space 44 is installed at the front of the second clamp handle part 21 of the wire or cable stripper 80. Furthermore, the cutting piece storage space 44 can carry cutting pieces 4 of various dimensions. Hence, different kinds of wire or cable can be stripped by changing cutting piece 4 of different sizes.

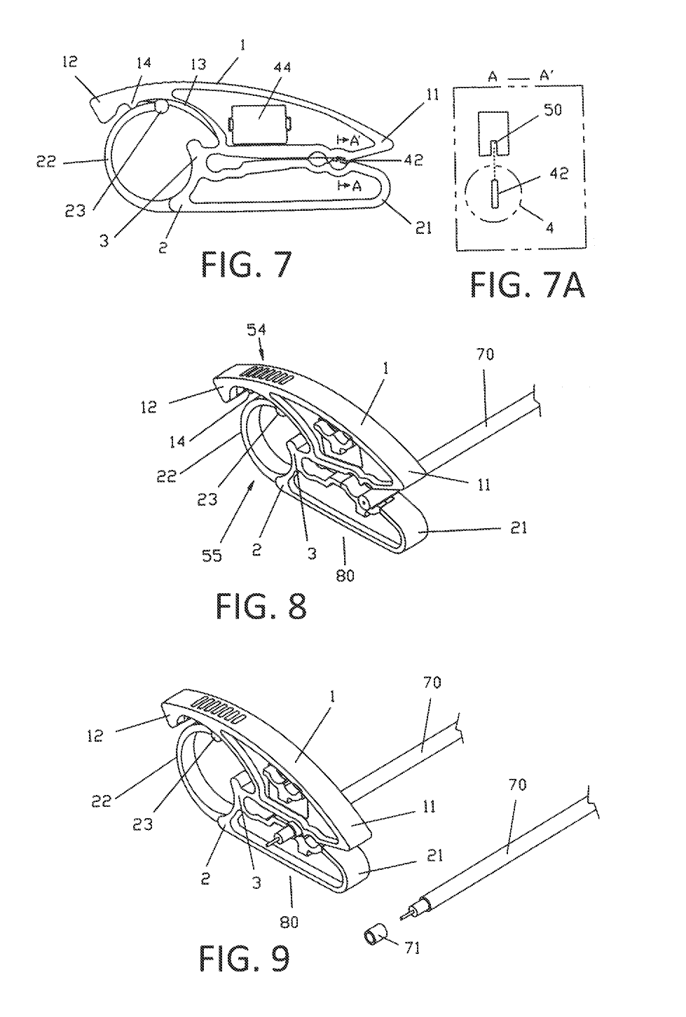

Referring to FIGS. 7 to 9, a wire and cable stripper in accordance with a third preferred embodiment of the invention is shown. The wire and cable stripper is applicable in cutting off an insulation layer 71 of a wire or cable 70. The wire and cable stripper 80 comprises the following components.

A first clamp handle part 1 has a front of the first clamp handle part 11 and a rear of the first clamp handle part 12. Moreover, there is a slot 13 at the rear of the first clamp handle part 12. A cavity 50 is disposed at the front of the first clamp handle part 11. A second clamp handle part 2 has a front of the second clamp handle part 21 and a rear of the second clamp handle part 22. The rear of the second clamp handle part 22 has a movable part 23 of the slot 13 of the corresponding rear of the first clamp handle part 12. The movable part 23 of the rear of the second clamp handle part 22 and the slot 13 of the rear of the first clamp handle part 12 push against each other. A connecting piece 3 connects the second clamp handle part 2 and the first clamp handle part 1. Moreover, the connecting piece 3 is a deformable component when user exerts a clamping force thereon. A cutting piece 4 which is a blade 42 installed in the cavity 50.

When applying external forces 54, 55 to the rear of the first clamp handle part 12 and the rear of the second clamp handle part 22, the movable part 23 of the rear of the second clamp handle part 22 will start to displace along the slot 13 of the rear of the first clamp handle part 12, stress the connecting piece 3 and cause it to deform, the front of the first clamp handle part 11 and the front of the second clamp handle part 21 will displace reversely from each other, and a wire or cable 70 will placed in the cavity 50. The connecting piece 3 tends to restore to its original position automatically when the external forces 54, 55 are removed. Furthermore, the reverse displacement of both the front of the first clamp handle part 11 and the front of the second clamp handle part 21 will also tend to disappear. This movement causes the front of the first clamp handle part 11 and the front of the second clamp handle part 21 to move closer to one and other and secures the previously placed wire or cable 70.

After the wire or cable 70 is secured, followed by rotating the wire and cable stripper 80, the cutting piece 4 will make a cut on the insulation layer of the wire or cable 70; or by fixating the wire and cable stripper 80, followed by rotating the wire or cable 70 to allow the cutting piece to make a cut on the insulation layer 71 of the wire or cable 70.

Also in this embodiment, the first clamp handle part 1 and the second clamp handle part are connected together through only one connecting piece 3.

Also in this embodiment, the first clamp handle part 1, the second clamp handle part 2, and the connecting piece 3 are connected together as one integral body.

Also in this embodiment, a position limiting piece 14 is installed at the rear of the first clamp handle part 12 of the wire or cable stripper 80, the position limiting 14 provides a limiting movable trajectory of the first clamp handle part 1 for the movable part 23 of the rear of the second clamp handle part.

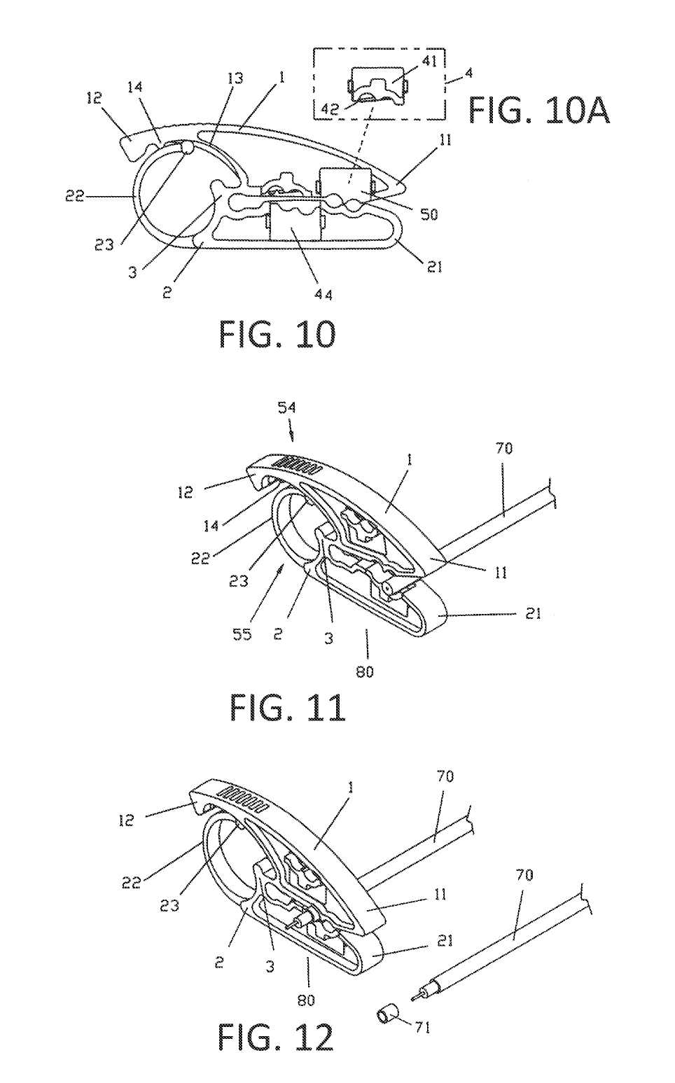

Referring to FIGS. 10 to 12, a wire and cable stripper in accordance with a fourth preferred embodiment of the invention is shown. The wire and cable stripper 80 is applicable in cutting off an insulation layer 71 of a wire or cable 70. The wire and cable stripper 80 comprises the following components.

A first clamp handle part 1 has a front of the first clamp handle part 11 and a rear of the first clamp handle part 12. Moreover, there is a slot 13 at the rear of the first clamp handle part 12. A cavity 50 is disposed at the front of the first clamp handle part 11. A second clamp handle part 2 has a front of the second clamp handle part 21 and a rear of the second clamp handle part 22. The rear of the second clamp handle part 22 has a movable part 23 of the slot 13 of the corresponding rear of the first clamp handle part 12. The movable part 23 of the rear of the second clamp handle part 22 and the slot 13 of the rear of the first clamp handle part 12 push against each other. A connecting piece 3 connects the second clamp handle part 2 and the first clamp handle part 1. Moreover, the connecting piece 3 is a deformable component when user exerts a clamping force thereon. A cutting piece 4 includes a blade base 41 and a blade 42. The blade 42 is installed on the blade base 41. The cutting piece 4 is installed in the cavity 50.

When applying external forces 54, 55 to the rear of the first clamp handle part 12 and the rear of the second clamp handle part 22, the movable part 23 of the rear of the second clamp handle part 22 will start to displace along the slot 13 of the rear of the first clamp handle part 12, stress the connecting piece 3 and cause it to deform, the front of the first clamp handle part 11 and the front of the second clamp handle part 21 will displace reversely from each other, and a wire or cable 70 will placed in the cavity 50. The connecting piece 3 tends to restore to its original position automatically when the external forces 54, 55 are removed. Furthermore, the reverse displacement of both the front of the first clamp handle part 11 and the front of the second clamp handle part 21 will also tend to disappear. This movement causes the front of the first clamp handle part 11 and the front of the second clamp handle part 21 to move closer to one and other and secures the previously placed wire or cable 70.

After the wire or cable 70 is secured, followed by rotating the wire and cable stripper 80, the cutting piece 4 will make a cut on the insulation layer of the wire or cable 70; or by fixating the wire and cable stripper 80, followed by rotating the wire or cable 70 to allow the cutting piece to make a cut on the insulation layer 71 of the wire or cable 70.

Also in this embodiment, the first clamp handle part 1 and the second clamp handle part are connected together through only one connecting piece 3.

Also in this embodiment, the first clamp handle part 1, the second clamp handle part 2, and the connecting piece 3 are connected together as one integral body.

Also in this embodiment, a position limiting piece 14 is installed at the rear of the first clamp handle part 12 of the wire or cable stripper 80, the position limiting 14 provides a limiting movable trajectory of the first clamp handle part 1 for the movable part 23 of the rear of the second clamp handle part.

Also in this embodiment, a cutting piece storage space 44 is installed at the front of the first clamp handle part 11 of the wire or cable stripper 80. Furthermore, the cutting piece storage space 44 can carry cutting pieces 4 of various dimensions. Hence, different kinds of wire or cable can be stripped by changing cutting piece 4 of different sizes.

Also in this embodiment, a cutting piece storage space 44 is installed at the front of the second clamp handle part 21 of the wire or cable stripper 80. Furthermore, the cutting piece storage space 44 can carry cutting pieces 4 of various dimensions. Hence, different kinds of wire or cable can be stripped by changing cutting piece 4 of different sizes.

While the invention has been described in terms of preferred embodiments, those skilled in the art will recognize that the invention can be practiced with modifications within the spirit and scope of the appended claims.

What is claimed is:

1. A wire and cable stripper for cutting off an insulation layer of a cable or a wire, the wire and cable stripper comprising:
a first clamp handle part having a front of the first clamp handle part and a rear of the first clamp handle part;
a slot disposed at the rear of the first clamp handle part;
a second clamp handle part having a front of the second clamp handle part and a rear of the second clamp handle part wherein the front of the second clamp handle part has a cavity, the rear of the second clamp handle part has a movable part of the slot of the corresponding rear of the first clamp handle part, the movable part of the rear of the second clamp handle part and the slot of the rear of the first clamp handle part push against each other, and the first clamp handle part and the second clamp handle part are connected together through a deformable connecting piece;
the first clamp handle part and the second clamp handle part are connected through only one deformable connecting piece;
the first clamp handle part and the second clamp handle part are connected by the deformable connecting piece to form integrally as a single body; and
a cutting piece disposed inside the cavity of the front of the second clamp handle part wherein a portion of the cutting piece protrudes out of a surface of the cavity of the front of the second clamp handle part.

2. The wire and cable stripper of claim 1, wherein the cutting piece is a blade base, and the blade base comprises of a blade.

3. The wire and cable stripper of claim 2, wherein the front of the first clamp handle part comprises a cutting piece storage space.

4. The wire and cable stripper of claim 2, wherein the front of the second clamp handle part comprises a cutting piece storage space.

5. A wire and cable stripper for cutting off an insulation layer of a cable or a wire, the wire and cable stripper comprising:
a first clamp handle part having a front of the first clamp handle part and a rear of the first clamp handle part;
a slot disposed at the rear of the first clamp handle part;
a cavity disposed at the front of the first clamp handle part;
a second clamp handle part having a front of the second clamp handle part and a rear of the second clamp handle part wherein
the rear of the second clamp handle part has a movable part of the slot of the corresponding rear of the first clamp handle part, the movable part of the rear of the second clamp handle part and the slot of the rear of the first clamp handle part push against each other, and the first clamp handle part and the second clamp handle part are connected together through a deformable connecting piece;
the first clamp handle part and the second clamp handle part are connected through only one deformable connecting piece;
the first clamp handle part and the second clamp handle part are connected by the deformable connecting piece to form integrally as a single body; and
a cutting piece disposed inside the cavity of the front of the first clamp handle part wherein a portion of the cutting piece protrudes out of a surface of the cavity of the front of the first clamp handle part.

6. The wire and cable stripper of claim 5, wherein the cutting piece is a blade base, and the blade base comprises of a blade.

7. The wire and cable stripper of claim 6, wherein the front of the first clamp handle part comprises a cutting piece storage space.

8. The wire and cable stripper of claim 6, wherein the front of the second clamp handle part comprises a cutting piece storage space.
